(19) United States
(12) Patent Application Publication
(10) Pub. No.: US 2005/0289363 A1
(43) Pub. Date: Dec. 29, 2005

(54) Method and apparatus for automatic realtime power management

(76) Inventors: Aaron M. Tsirkel, San Jose, CA (US); Animesh Mishra, Pleasanton, CA (US); Paul S. Diefenbaugh, Beaverton, OR (US); Jose A. Godinho, Sunnyvale, CA (US)

Correspondence Address: INTEL CORPORATION, P.O. BOX 5326, SANTA CLARA, CA, 95056-5326, US

(21) Appl. No.: 10/879,927

(22) Filed: Jun. 28, 2004

(51) Int. Cl. G06F 1/26

(52) U.S. Cl. 713/300

(57) ABSTRACT

A power management system is disclosed using a combination of user presence detection and user interaction detection. An image-capturing device is to remain in a low power state as long as the user interaction is detected. When no user interaction is detected, the image-capturing device is placed in a normal power state to capture an image. The image is analyzed to determine user presence. When the user presence is detected, the image-capturing device is placed in the low power state.

### FIELD OF INVENTION

The present invention relates generally to computer systems and more specifically to power management for computer systems.

### BACKGROUND

Computer systems are becoming increasingly pervasive in our society, including everything from small handheld electronic devices, such as personal digital data assistants and cellular phones, to application-specific electronic components, such as set-top boxes and other consumer electronics, to medium-sized mobile and desktop systems to large workstations and servers. With deployment of wireless technology, the battery life became very critical characteristic of mobile systems.

To provide more powerful computer systems for consumers, designers strive to continually increase the operating speed of the processor. A by-product of increasing processor speed is an increase in the amount of power consumed by the processor. The increased system power consumption result in need for bigger thermal/cooling system, bigger power delivery system and reducing battery life.

One approach to reducing power consumption of a computer system is based on a Display Power Management System (DPMS) protocol. DPMS is used to selectively shut down parts of the computer system's video display circuitry after a period of inactivity. With a motherboard and a display that support DPMS, power consumption by the computer system, especially by the display may be greatly reduced. The motherboards that support DPMS often have a BIOS (basic input/output system) setting to enable the power consumption option. The BIOS setting controls a length of time the system must be idle (i.e., no activity detected from the user) for the display to be powered off.

The length of the idle time may be specified in minutes or hours, or it may be set to “Disabled” or “Never”. The computer system then tries to detect user's activity during the idle time. User's activities may include, for example, pressing of a key on a keyboard, movement of a mouse, etc. After no activity is detected during the idle time and at expiration of the idle time, the computer system sends appropriate control signals to the display to power off the display. When the display is powered off and the system detects user's activity, the system sends appropriate control signals to power on the display.

Another approach to power management is by setting user's preference using the operating system or application software. For example, power to the display can be managed by setting a power off option in a power management properties menu to a certain fixed expiration value. The expiration value may be set to any value provided in a pop-up window ranging from 1 minute to “never”. The expiration value is static and remains the same until another value is selected. FIG. 1 illustrates a prior art example of a pop-up window used to specify power management preferences. As illustrated in FIG. 1, power can be managed by setting user's preference to turn off monitor, hard disks and to put the system in standby mode.

### BRIEF DESCRIPTION OF THE DRAWINGS

The present invention is illustrated by way of example, and not limitation, in the figures of the accompanying drawings in which like references indicate similar elements and in which:

FIG. 1 illustrates a prior art example of a pop-up window used to specify power management preferences.

FIG. 2 is a diagram illustrating an example of a computer system according to one embodiment.

FIG. 3 illustrates an example of biometric characteristics that may be used to detect a user.

FIG. 4 is a diagram illustrating examples of positions of a user in front of the computer system.

FIG. 5 is a flow diagram illustrating an example of a power management process, according to one embodiment.

FIG. 6 is a diagram illustrating power saving examples when comparing with the timer based technique, in accordance with one embodiment.

### DETAILED DESCRIPTION

A method and apparatus for reducing power consumption of computer systems using a combination of user presence and input detection is disclosed. For one embodiment, the image-capturing device is coupled to the computer system and may be activated when there is no action by a user of the computer system. The image-capturing device may be used to help determine presence or absence of the user.

In the following description, for purposes of explanation, numerous specific details are set forth in order to provide a thorough understanding of the present invention. It will be evident, however, to one skilled in the art that the present invention may be practiced without these specific details. In other instances, well-known structures, processes and devices are shown in block diagram form or are referred to in a summary manner in order to provide an explanation without undue detail.

As used herein, the term “when” may be used to indicate the temporal nature of an event. For example, the phrase “event ‘A’ occurs when event ‘B’ occurs” is to be interpreted to mean that event A may occur before, during, or after the occurrence of event B, but is nonetheless associated with the occurrence of event B. For example, event A occurs when event B occurs if event A occurs in response to the occurrence of event B or in response to a signal indicating that event B has occurred, is occurring, or will occur.

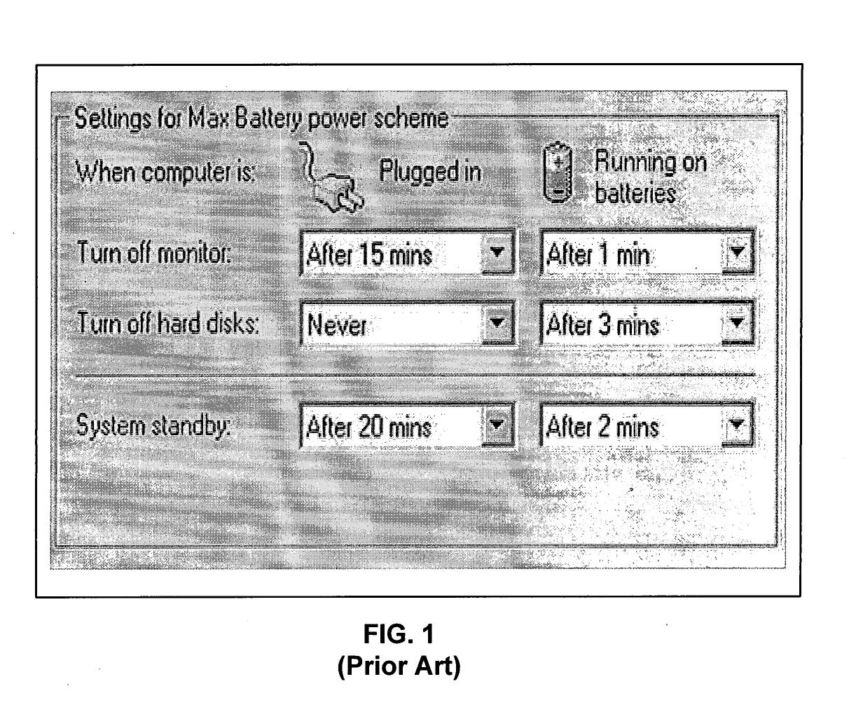

One disadvantage of the techniques illustrated in FIG. 1 is that there is no reduction in power consumption during the idle time when the computer system is not in use. The idle time of a computer system may be extensive. For example, the idle time may range between approximately 50% and 80% of the total time that a user is supposedly using the computer system. For example, although the user may be positioned in front of the computer system, the user may not be using the keyboard or the mouse and may be reading or talking on the phone, etc. Thus, it would be advantageous to further reduce the power consumption of the computer system during the idle times.

System

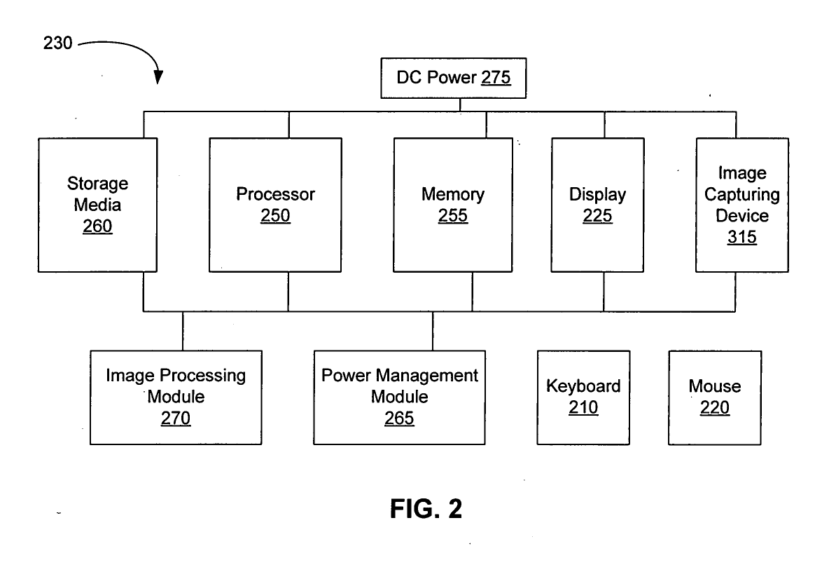

FIG. 2 is a diagram illustrating an example of a computer system according to one embodiment. Computer system 230 may be a portable computer system, although it may also be a non-portable computer system (e.g., a desktop system, a server, etc.). The computer system 230 may be used with a direct current (DC) power source 275 such as, for example, a battery. Alternatively, it may also be used with an alternating current (AC) power source (not shown). The computer system 230 may include a central processing unit (CPU) or processor 250, and memory 255 which may be a combination of, for example, random access memory (RAM), read-only memory (ROM), etc. The computer system 230 may include a storage media 260 which may be, for example, a disk drive, etc. The computer system 230 may also include a keyboard 210, a cursor-control device 220, and a display 225.

For one embodiment, the computer system 230 may also include an image-capturing device 315 such as, for example, a digital camera. The image-capturing device 315 may be coupled to the computer system 230 using a coupling device (not shown). Alternatively, the image-capturing device 315 may be integrated in the computer system 230 via the display 225. Other methods for coupling the image-capturing device 315 with the computer system 230 may also be used. For one embodiment, the image-capturing device 315 may be positioned to capture an image of an area in front of the computer system 230. Typically, when user is positioned near or in front of the computer system 230, the user may be included in an image captured by the image-capturing device 315. Depending on the operating platform of the computer system 230 (e.g., Windows, etc), a device driver (not shown) may be used to enable the image-capturing device 315 to interact with the computer system 230.

For one embodiment, the computer system 230 may include a power management module 265. The power management module 265 may control power consumption of various components in the computer system 230. For example, the power management module 265 may control power consumption of the display 225, the processor 250, the storage media 260, etc. The power management module 265 may control power consumption of the various components using known techniques. For example, the power management module 265 may control power consumption of the processor 250 using different processor power consumption states (e.g., C0, C1, C2, and C3) as sets forth in the Advanced Configuration and Power Interface (ACPI) Specification (Rev. 2.0a, Mar. 31, 2002). The power management module 265 may be implemented in software, hardware, or a combination of both software and hardware.

Image Processing

For one embodiment, the computer system 230 may include an image-processing module 270. The image-processing module 270 may be used to process an image captured by the image-capturing device 315. The image-processing module 270 may support different image formats so that it can process images captured in different formats by the image-capturing device 315. When the image-processing module 270 receives the image, it may perform various operations to analyze the image. The image-processing module 270 may be implemented in software, hardware, or a combination of both hardware and software. For one embodiment, a sampling rate may be selected to control the operations of the image-capturing device 315. For example, the sampling rate may enable the image-capturing device 315 to capture an image of the area in front of the computer system 230 based on a selected frequency (e.g., every two seconds). Depending on the situation, the captured image may or may not include an image of a user of the computer system 230.

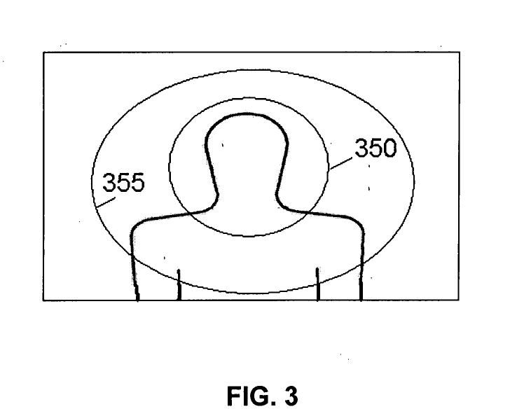

FIG. 3 illustrates an example of biometric characteristics that may be used to detect a user. For one embodiment, the biometric characteristics may be a facial contour. For example, the biometric characteristics may be detected by identifying the facial contour illustrated as image 350. The facial contour may further be detected by the skin hue, which may be represented using primary colors (red (R), green (G), blue (B)). For example, when the facial contour is detected and the skin hue is also detected within the facial contour, then it's likely that a user's face (an RGB image) is detected, rather than any other object that happens to have a similar contour. There are known techniques that may be used to detect the skin hue. The RGB image of the user's face may be converted into HSV (Hue, Saturation, and Value) color space to reduce variations due to, for example, different types of image-capturing device, different settings, etc. In this example, when the user's face is detected, the user may be considered present provided certain criteria are met.

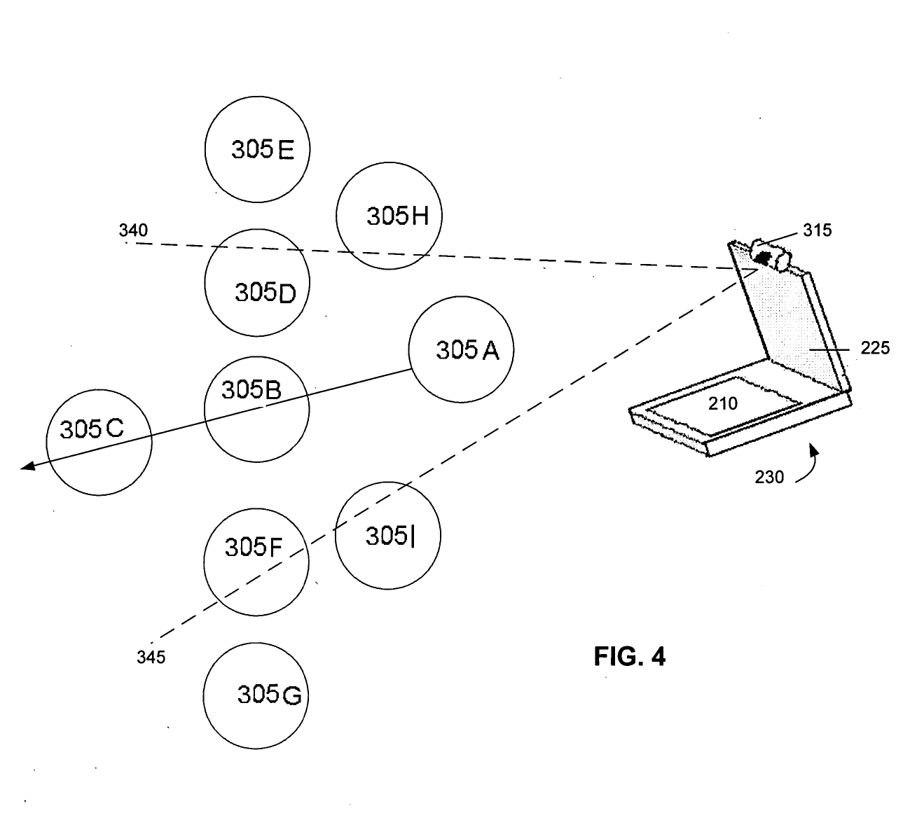

FIG. 4 is a diagram illustrating examples of positions of a user in front of the computer system. For one embodiment, the user may be detected by the image-processing module 270 in a captured image as long as the user stays within a certain zone in front of the computer system 230. For example, the zone may include an area viewable from a viewfinder (not shown) of the image-capturing device 315. The zone is illustrated in FIG. 4 as the area between the dotted lines 340 and 345. For example, the image-processing module 270 may be able to detect the user in an image when the user is at position 305A, 305B, or 305C. For one embodiment, the image-processing module 270 may also be able to detect a user when the user is positioned partially out of the zone, as illustrated in position 305D or 305F. A detection threshold may be used to determine when the user is detected. For example, the detection threshold may be set at ninety (90) percent, and when 90 percent or more of the facial contour is detected, it may be concluded that the user is detected. Thus, the user would not be detected in the image when being only partially in the zone, as illustrated in position 305H or 3051. Of course, the user would not be detected when being completely out of the zone, as illustrated in positions 305E and 305G.

For one embodiment, although the user may be detected in the image, the user may be positioned too far from the computer system 230 to be considered present, as illustrated in position 305C. A presence threshold may be used to determine presence or absence of a detected user. For example, the presence threshold may specify an acceptable size of the detected biometric characteristics (e.g., facial contour). The presence threshold may also specify an acceptable area of detected skin hue. Other techniques may also be used to make the presence determination depending on the biometric characteristics.

Power Management Process

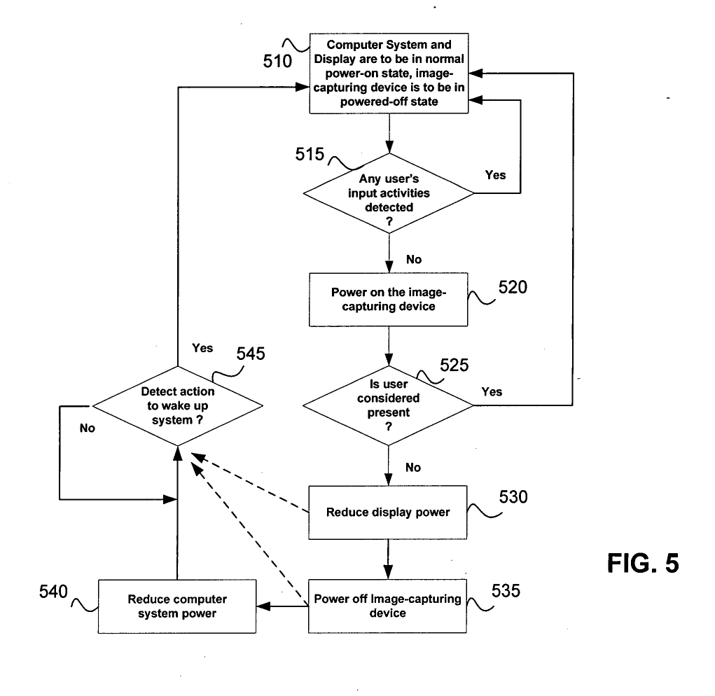

FIG. 5 is a flow diagram illustrating an example of a power management process, according to one embodiment. In this example, the process may be used to detect whether a user of a computer system is using the computer system and/or is positioned near the computer system.

For one embodiment, the image-capturing device is normally powered off when the user is positioned in front of or near (or present) the computer system. The image-capturing device may also be powered off or placed in a low power state when the user is interacting with the computer system. This may be determined by, for example, detecting keyboard activities, mouse activities, touch-screen input, voice input, etc. In this way, little or no power may be consumed by the image-capturing device while the user is present or interacting with the computer system.

At block 510, the computer system and the associated display are in a normal power-on state, and the image-capturing device is in a low power or power-off state. At block 515, a test is made to determine if the user is interacting with the computer system. If any interaction is determined, the process flows to block 510 where no power consumption modification may need to be performed. From block 515, when it is determined that there is no interaction by the user, the process flows to block 520, where the image-capturing device is powered on. It may be possible that there is a delay between a time when no user's interaction is detected and the time when the image-capturing device is powered on. This delay may avoid frequent powering off and powering on the image-capturing device when the user may be temporarily away from the computer system.

For one embodiment, after the image-capturing device is powered on, an image is captured, and a test may be performed to determine if the user is present, as shown in block 525. This determination may be performed by analyzing the image captured by the image-capturing device. From block 525, if the user is present, the process flows to block 510 where no power consumption modification may need to be performed.

From block 525, when the user is not present, appropriate power savings operations may be performed. It may be possible that there is a delay between a time when it is detected that the user is not present and when power savings operations are performed. At block 530, the power consumed by the display may be reduced. This may include, for example, dimming the display or powering off the display. At block 535, the image-capturing device may be placed in a low power state or powered off. At block 540, the computer system may be placed in a reduced power state. The process may then flow to block 545 and waits for a wake up signal. It may be noted that as the operations associated with blocks 530 and 535 are being performed, the user may return to the computer system. This is illustrated in the example as dotted lines between blocks 545 and blocks 530 and 535. For one embodiment, when the user returns to the computer system after a being away, the user may need to provide a wake up signal to the computer system to return the computer system to the normal power on state. This may include, for example, pressing a normal key or a function key (e.g., F1 key) on the keyboard.

From block 545, if no wake up signal is detected, the computer system and other associated components may remain in the low power consumption states. This may include being in a power-off state. However, when one or more wakeup signals is received, the process then flows from block 545 to block 510, where the processor, the display, etc. are placed in the normal power-on states. Note that the image-capturing device may remain in the low power or power-off state.

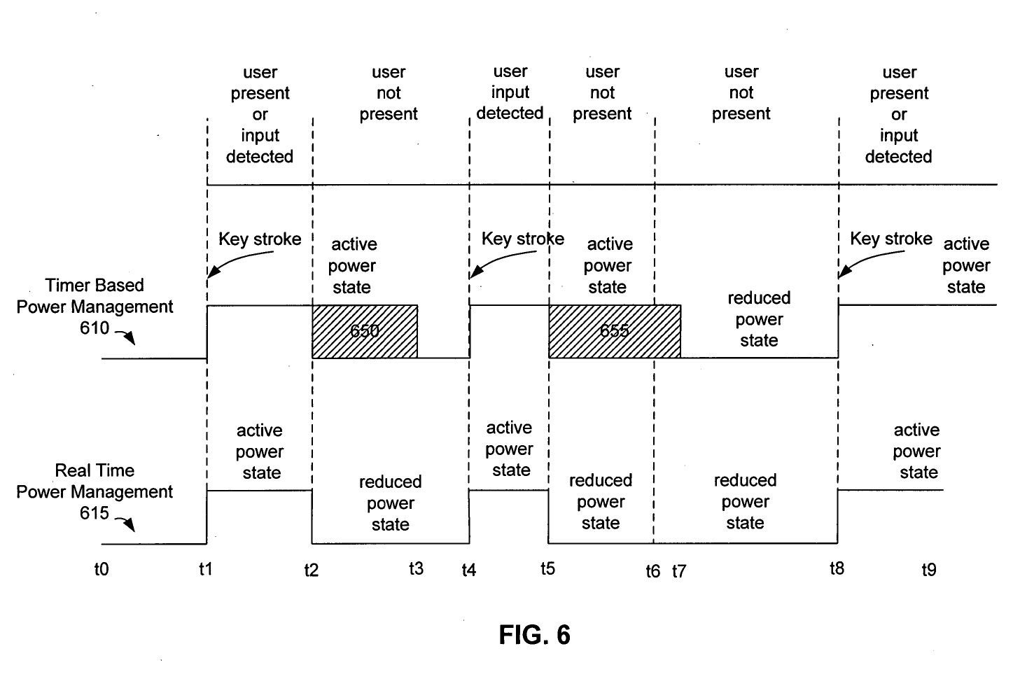

FIG. 6 is a diagram illustrating power saving examples when comparing with the timer based technique, in accordance with one embodiment. Listed at the top of FIG. 6 are some examples of different user status which may include being present, not present, and/or interacting with the computer system. In this example, the active power state and the reduced power state refer to the state of the display where the active power state may be a normal power-on state and the reduced power state may be a power-off state.

Graph 610 in illustrates power state of the display using the prior art timer-based technique. For the purpose of demonstrating advantages of embodiments of the present invention over the prior art techniques, a single keystroke is entered at times t1, t4 and t8. The single keystroke may cause the display to be in the power on state. Using the timer-based technique, the display remains in the power on state for the period between times t1 and t3, t4 and t7, and for sometime after t8. The display may go into a power saving or reduced power state between times t3 and t4, and between times t7 and t8. This timer-based technique does not take into account presence or absence of the user 305 and may not be efficient because it may force the display to remain in the power on state longer than necessary.

Graph 615 in FIG. 6 illustrates power states of the display using the combination of user presence and input detection or real time techniques. At time t0, the display is in a low power sate. The display is placed into the power on state after the keystroke is entered at time t1. The display remains in the power on state until time t2. From time t2 to t3 and to t4, the display is placed in the reduced or low power state because the user is not interacting with the computer system and/or because the user is not present. Note that the display is in the reduced power state for a period t3-t2 longer than when the timer-based technique is used. This power saving difference is illustrated as the shaded block 650.

At time t4, a keystroke is detected and the display is placed in the power on state. At time t5, no user interaction is detected and no user is present, the display is placed in the reduced power state through times t6, t7, and up to time t8 where another keystroke is detected. Note that the display is in the reduced power state for a period t7-t5 longer than when the timer-based technique is used. This power saving difference is illustrated as the shaded block 655.

Thus, for the same situations, the graph 615 illustrates that the display may be placed in the reduced or low power state using the keyboard detection and user presence techniques more often than the timer-based technique illustrated in the graph 610. For one embodiment, the combination technique may be used in conjunction with the prior art timer-based techniques to provide further power saving.

Computer Readable Media

The operations of these various methods may be implemented by a processor in a computer system, which executes sequences of computer program instructions which are stored in a memory which may be considered to be a machine-readable storage media. For example, the computer system may be the computer system 230, and the machine-readable storage media may be the storage media 260 illustrated in FIG. 2. The memory may be random access memory (RAM), read only memory (ROM), a persistent storage memory, such as mass storage device or any combination of these devices. Execution of the sequences of instruction causes the processor to perform operations according to one embodiment the present invention such as, for example, the operations described in FIG. 5.

Techniques for reducing power consumption in computer systems by using an image-capturing device and detecting user interactions have been disclosed. The techniques may operate in real time allowing power consumption to be reduced shortly after absence of the user is determined. The techniques do not require the image-capturing device to be powered on all the times. Furthermore, the techniques may enable the same image-capturing device to be used for other applications while the user is interacting with the computer system.

This invention has been described with reference to specific exemplary embodiments thereof. It will, however, be evident to persons having the benefit of this disclosure that various modifications and changes may be made to these embodiments without departing from the broader spirit and scope of the invention. The specification and drawings are, accordingly, to be regarded in an illustrative rather than a restrictive sense.

1. A system, comprising:
a processor;
a display coupled to the processor; and
an image-capturing device coupled to the processor, wherein power consumption of the image-capturing device is reduced when user interaction with the computer system is detected.

2. The system of claim 1, wherein the power consumption of the image-capturing device is restored when no user interaction with the computer system is detected.

3. The system of claim 2, wherein a first delay occurs between when no user interaction is detected and when the power consumption of the image-capturing device is restored.

4. The system of claim 2, wherein the image-capturing device is to capture an image used for detecting user presence.

5. The system of claim 4, wherein when no user presence is detected, power consumption of one or more of the display and the processor is reduced.

6. The system of claim 4, wherein a second delay occurs between when no user presence is detected and when the power consumption of one of more of the display and the processor is reduced.

7. The system of claim 5, wherein subsequent to receiving a wake up signal, the power consumption of one or more of the display and the processor is restored.

8. The system of claim 7, wherein subsequent to receiving the wake up signal, the power consumption of the image-capturing device is reduced.

9. The system of claim 8, wherein the wake up signal is generated by pressing a key on a keyboard coupled to the processor.

10. A method, comprising:
when no user interaction with a computer system is detected, increasing power consumption of an image-capturing device to capture an image to be analyzed for user presence; and
maintaining power consumption of the computer system when the user presence is detected.

11. The method of claim 10, wherein maintaining the power consumption of the computer system includes reducing the power consumption of the image-capturing device.

12. The method of claim 11, wherein increasing the power consumption of the image-capturing device includes powering on the image-capturing device, and wherein reducing the power consumption of the image-capturing device includes powering off the image-capturing device.

13. The method of claim 10, further comprising reducing the power consumption of the computer system when the user presence is not detected.

14. The method of claim 13, wherein reducing the power consumption of the computer system includes reducing power consumption of one or more of a display and a processor associated with the computer system.

15. The method of claim 14, wherein reducing the power consumption of the computer system further includes reducing the power consumption of the image-capturing device.

16. The method of claim 10, wherein the user interaction includes one or more of keyboard and mouse interactions.

17. A machine-readable medium including machine readable instructions that, if executed by a computer system, cause the computer system to perform a method comprising:
when a user is interacting with the computer system, keeping an image-capturing device powered off, otherwise powering on the image-capturing device to determine if the user is present; and
when the user is determined to be present, powering off the image-capturing device.

18. The machine-readable medium of claim 17, further comprising:
when the user is determined to be not present, reducing power consumption of a display associated with the computer system.

19. The machine-readable medium of claim 18, further comprising:
when the user is determined to be not present, reducing power consumption of a processor associated with the computer system.

20. The machine-readable medium of claim 19, wherein the power consumption of one or more of the display and the processor is restored upon receiving a wake up signal from the user.

21. The machine-readable medium of claim 20, wherein upon receiving the wake up signal from the user, the image-capturing device remains powered off.
